(19) United States
(12) Patent Application Publication
(10) Pub. No.: US 2024/0228281 A9
(43) Pub. Date: Jul. 11, 2024

(54) METHOD OF PRODUCING LITHIUM SULFIDE

(71) Applicant: MITSUBISHI MATERIALS CORPORATION, Tokyo (JP)

(72) Inventors: Fumitake Kikuchi, Ibaraki (JP); Kanji Kuba, Ibaraki (JP); Shotaro Kakuki, Ibaraki (JP)

(73) Assignee: MITSUBISHI MATERIALS CORPORATION, Tokyo (JP)

(21) Appl. No.: 18/278,866

(22) PCT Filed: Mar. 4, 2022
(86) PCT No.: PCT/JP2022/009417

§ 371 Date: Aug. 25, 2023

(30) Foreign Application Priority Data
Mar. 5, 2021 (JP) 2021-035650

(51) Int. Cl. C01B 17/26; H01M 10/0562

(52) U.S. Cl. CPC C01B 17/26; H01M 10/0562; C01P 2002/72; C01P 2002/74; C01P 2006/40; H01M 2300/0068

(57) ABSTRACT

Provided is a more appropriate method of producing lithium sulfide having high ionic conductivity and no by-products generated. The method of producing lithium sulfide includes a temperature rising step (Step S14) of reducing lithium sulfate fed into a furnace in a state of heating to a temperature of more than 700° C. under an atmosphere of a reduced pressure of 0.05 MPa or less.

### FIELD

The present invention relates to a method of producing lithium sulfide.

### BACKGROUND

Lithium sulfide has been known as a solid electrolyte for lithium batteries. Patent Literature 1 has disclosed a method of producing lithium sulfide by reacting lithium hydroxide with hydrogen sulfide in an aprotic organic solvent to form lithium hydrosulfide and further promoting the reaction.

Patent Literature 2 has disclosed a method of producing lithium sulfide without using organic solvents. In Patent Literature 2, lithium sulfide is generated on metallic lithium by reacting metallic lithium with sulfur vapor or hydrogen sulfide. Thereafter, unreacted metallic lithium is melted at high temperature to diffuse and permeate into the already generated lithium sulfide, and thereafter the resultant product is cooled. Thereafter, the metallic lithium is reacted again with sulfur vapor or hydrogen sulfide to generate lithium sulfide. This cycle is repeated to react the metallic lithium to one hundred percent.

Patent Literature 3 has disclosed a method of producing lithium sulfide by reacting lithium carbonate with hydrogen sulfide.

Patent Literature 4 has disclosed a method of producing lithium sulfide without using hydrogen sulfide. In Patent Literature 4, lithium sulfate and carbon powder are controlled to fine particles and mixed to increase a reaction area and decrease unreacted raw materials.

### CITATION LIST

### Patent Literature

Patent Literature 1: Japanese Patent Application Laid-open No. 2006-151725
Patent Literature 2: Japanese Patent Application Laid-open No. H9-110404
Patent Literature 3: Japanese Patent Application Laid-open No. 2012-221819
Patent Literature 4: Japanese Patent Application Laid-open No. 2013-227180

### SUMMARY

### Technical Problem

The technology described in Patent Literature 1 allows a sulfide solid electrolyte having high ionic conductivity to be prepared, but increases costs due to the use of the organic solvents. The technology described in the Patent Literature 2 requires that the cycle of the reaction is repeated, which increases costs. The technology described in Patent Literature 3 uses toxic hydrogen sulfide gas, which causes the control to be difficult and the high level of caution for ensuring safety to be required. The technology described in Patent Literature 4 increases the number of processes because lithium sulfate and carbon powder are controlled to fine particles and mixed. In the case where the production is performed in equipment such as a rotary kiln, the fine particles may scatter inside the equipment and thus the recovered amount may be decreased.

The conventional production methods in which reduction is performed using lithium sulfate and the carbon material without using hydrogen sulfide tends to have lower ionic conductivity when the solid electrolyte is prepared using the generated lithium sulfide, as compared to other production methods. As the cause of this problem, it has been found that lithium carbonate or lithium oxide is generated as a by-product under many conditions to decrease the purity of lithium sulfide.

As described above, there is room for improvement in the method of producing lithium sulfide that is used for lithium batteries having high ionic conductivity and no by-products generated.

The present invention has been made in view of the above description and an object of the present invention is to provide a more suitable method of producing lithium sulfide having high ionic conductivity and no by-products generated.

### Solution to Problem

To solve the above problems and achieve the object, a method of producing lithium sulfide according to the present invention includes a temperature rising step of reducing lithium sulfate fed into a furnace in a state of heating to a temperature of more than 700° C. under an atmosphere of a reduced pressure of 0.05 MPa or less.

### Advantageous Effects of Invention

The method of producing lithium sulfide according to the present invention exhibits an effect that lithium sulfide having high ionic conductivity and no by-products generated can be more appropriately produced.

### BRIEF DESCRIPTION OF DRAWINGS

FIG. 1 is a flowchart illustrating the steps of a method of producing lithium sulfide.

FIG. 2 is a schematic view illustrating one example of a production apparatus including a rotary kiln.

FIG. 3 is a graph illustrating the test result of Example 1 and illustrating the measurement result of X-ray diffraction measurement.

FIG. 4 is a graph illustrating the test result of Example 2 and illustrating the measurement result of X-ray diffraction measurement.

FIG. 5 is a graph illustrating the test result of Example 3 and illustrating the measurement result of X-ray diffraction measurement.

FIG. 6 is a graph illustrating the test result of Example 4 and illustrating the measurement result of X-ray diffraction measurement.

FIG. 7 is a graph illustrating the test result of Example 5 and illustrating the measurement result of X-ray diffraction measurement.

FIG. 8 is a graph illustrating the test result of Comparative Example 1 and illustrating the measurement result of X-ray diffraction measurement.

FIG. 9 is a graph illustrating the test result of Comparative Example 2 and illustrating the measurement result of X-ray diffraction measurement.

FIG. 10 is a graph illustrating the test result of Comparative Example 3 and illustrating the measurement result of X-ray diffraction measurement.

FIG. 11 is a graph illustrating the test results of respective Examples and Comparative Examples and illustrating the AC impedance measurement.

### DESCRIPTION OF EMBODIMENTS

Hereinafter, the present invention will be described in detail with reference to the drawings. The present invention is not limited by the embodiments for implementing the invention described below (hereinafter, referred to as embodiments). In the constituents in the following embodiments, constituents that those skilled in the art can easily assume, constituents that are substantially the same, and constituents that are considered to be what is called the range of equivalency are included. The constituents disclosed in the following embodiments can be appropriately combined.

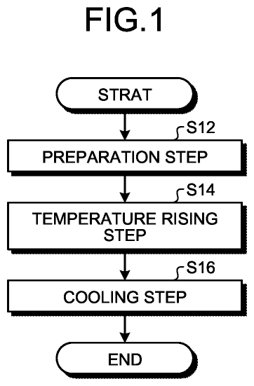

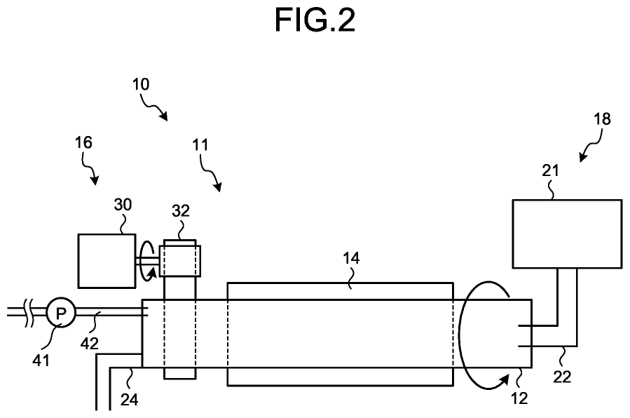

Using FIG. 1 and FIG. 2, the method of producing lithium sulfide will be described. FIG. 1 is a flowchart illustrating the steps of the method of producing lithium sulfide. FIG. 2 is a schematic view illustrating an example of a production apparatus including a rotary kiln.

In the method of producing lithium sulfide of this embodiment, lithium sulfate serving as a raw material and a reducing agent are placed in one furnace and a temperature is raised to produce lithium sulfide. At the time of the reaction of lithium sulfate with the reducing agent, the reaction is performed under a reduced pressure atmosphere.

The average particle diameter of lithium sulfate is preferably 10 μm or more and 100 μm or less, more preferably 15 μm or more and 80 μm or less, and further preferably 30 μm or more and 50 μm or less. Lithium sulfate serving as the raw material in the method of producing lithium sulfide of this embodiment is not required to be in fine particle form. Therefore, in the case where lithium sulfate is produced using an apparatus such as a rotary kiln 11, the possibility of difficulty in recovery can be reduced even when the powdered lithium sulfate scatters inside a kiln body (furnace) 12 in the rotary kiln 11.

The reducing agent may be any materials of which main component is carbon such as activated carbon, and is not limited. The case where the reducing agent is activated carbon will be described in this embodiment. The activated carbon preferably has an average particle diameter of 1 μm or more and 20 μm or less.

As illustrated in FIG. 1, the method of producing lithium sulfide includes a preparation step (step S12) of feeding lithium sulfate and the reducing agent into a furnace, a temperature rising step (step S14) of raising temperature of the furnace, and a cooling step (step S16) of cooling the furnace.

[Preparation Step]

At the preparation step, lithium sulfate and the reducing agent are fed into the furnace at a predetermined molar ratio. At the preparation step, lithium sulfate and the reducing agent are mixed at a predetermined molar ratio. For example, the molar ratio of lithium sulfate to the activated carbon serving as the reducing agent is preferably 2 or more and 4 or less in terms of a C/Li₂SO₄ ratio.

[Temperature Rising Step]

At the temperature rising step, lithium sulfate and the reducing agent fed into the furnace are heated in the furnace to raise the temperature. The temperature rising step is performed under a reduced pressure atmosphere. For example, the temperature rising step is performed under an atmosphere in which the pressure in the furnace is reduced to 0.05 MPa or less. The pressure may be measured at a place where the temperature in the furnace is not affected. For example, the measurement is performed using a Bourdon tube pressure gauge or a Pirani vacuum gauge. In order to perform the temperature rising step under the reduced pressure atmosphere, for example, a pump is continuously used to perform the reduction under the reduced pressure when the temperature rising step is performed. For example, it is performed in a state where the furnace is heated at a temperature of higher than 700° C.

At the temperature rising step, lithium sulfate is reduced by the reducing agent. At the temperature rising step, for example, the temperature is raised to a range of 750° C. or more and 1,000° C. or less and preferably 850° C. or more and 950° C. or less. A temperature range of 700° C. or less results in the slow rate of the reaction of lithium sulfate with the reducing agent and thus productivity is low. A temperature range of more than 1,000° C. results in low productivity because the temperature is raised more than necessity. A temperature range of 950° C. or more allows remaining unreacted lithium sulfate to melt because this temperature range is equal to or higher than the melting point of lithium sulfate serving as the raw material. A temperature range of 750° C. or more and 1,000° C. or less allows a reaction rate to be fast, resulting in high productivity. A temperature range of 850° C. or more and 950° C. or less allows lithium sulfate not to melt and thus lithium sulfide retaining the particle shape to be obtained.

At the temperature rising step, the temperature preferably reaches the desired temperature range by raising temperature at a temperature rising rate of 5° C./min or more from the start of heating. At the temperature rising step, a heating time in the desired temperature range is preferably 5 minutes or more and 90 minutes or less. The reason why the heating time is preferably set within the above range is because maintaining the product at a high temperature for a long period of time gradually causes grain growth, resulting in a decrease in reactivity.

In the method of reducing lithium sulfate with carbon, immediate removal of gases generated at the time of the reduction is important in order to reduce the by-products composed of lithium carbonate and lithium oxide. Therefore, in this embodiment, the reduction is performed by continuously using a pump having a sufficiently large throughput against the generated gases to maintain the atmosphere under reduced pressure. This allows high-purity lithium sulfide to be obtained at low costs.

It has been found that the composition of the gases generated at the time of reduction varies depending on the temperature. It has been found that in a temperature of about 750° C. or more and about 850° C. or less, at which the reaction starts, CO₂ is mainly generated and a CO ratio becomes higher as the temperature is raised. The oxygen potential of the gases generated at the time of the reduction, in other words, the CO/CO₂ ratio in the reducing atmosphere is also an important factor for reducing the by-products. In the reaction at low temperature, the CO/CO₂ ratio is out of the proper range, and thus lithium sulfide alone is difficult to obtain even at a high exhaust rate. Conditions having very high exhaust rate require to prepare a pump having higher performance, which increases costs. Therefore, performing the reduction at a temperature of 850° C. or more while the pressure is being reduced to 0.05 MPa or less allows lithium sulfide having high purity and no by-products generated to be obtained.

[Cooling Step]

At the cooling step, the furnace is cooled to 200° C. or less after the temperature rising step. At the cooling step, the furnace of which temperature is raised is naturally cooled.

After the cooling step, lithium sulfide is taken out from the furnace.

The preparation step, the temperature rising step, and the cooling step may be performed, for example, using a production apparatus 10 having the rotary kiln 11.

[Production Apparatus]

The production apparatus 10 is an apparatus for producing lithium sulfide by placing lithium sulfate serving as a raw material and activated carbon serving as the reducing agent in a single furnace and raising the temperature under a reduced pressure atmosphere. The production apparatus 10 includes the rotary kiln 11, a material feeder 18, a material discharge pipe 24, and a pump 41.

The rotary kiln 11 includes the kiln body 12, a heater 14, and a driving unit 16. The kiln body 12 is a cylindrical member. The kiln body 12 is preferably arranged with a cylindrical central axis being inclined with respect to the horizontal direction so that an end part of the material feeder 18 side is located upward in a vertical direction relative to the other end part. The heater 14 heats the kiln body 12.

The driving unit 16 rotates the kiln body 12 using the cylindrical central axis as a rotation axis. The driving unit 16 includes a driving source 30 and a transmission mechanism 32. The driving source 30 such as a motor generates rotational power. The transmission mechanism 32 transmits the rotational power of the driving source 30 to the kiln body 12.

The material feeder 18 feeds lithium sulfate and activated carbon into the rotary kiln 11. The material feeder 18 includes a material reservoir 21 and a material supply pipe 22. The material reservoir 21 stores lithium sulfate and activated carbon. The material supply pipe 22 connects the material reservoir 21 to the kiln body 12. The material supply pipe 22 is connected to the upstream side of a conveying path of lithium sulfate and activated carbon in the kiln body 12. The material supply pipe 22 supplies lithium sulfate and activated carbon from the material reservoir 21 to the kiln body 12.

The material discharge pipe 24 is connected to an end part of the kiln body 12 opposite to the other end part to which the material supply pipe 22 is connected. The material discharge pipe 24 is connected to the downstream side of the conveying path of lithium sulfate and activated carbon in the kiln body 12. The material discharge pipe 24 discharges the lithium sulfide produced by passing through the kiln body 12.

The pump 41 is connected to the kiln body 12 through an exhaust pipe 42. The pump 41 depressurizes the inside of the kiln body 12. The pump 41 has a throughput larger than the amount of the gases generated at the time of the reaction in the kiln body 12. The pump to be used is not limited. For example, a combination of a rotary pump and a mechanical booster pump or an oil diffusion pump may be used. Depending on the size of the furnace and the amount of reduction process to be performed at one time, the conditions described above can be sufficiently achieved using a rotary pump alone having a throughput of about 150 L/min, which is generally available for purchase.

In the production apparatus 10 configured as described above, first, lithium sulfate and activated carbon in a predetermined molar ratio are fed into the kiln body 12 of the rotary kiln 11 from the material feeder 18. The lithium sulfate and the reducing agent fed into the kiln body 12 are already mixed. Thereafter, at the temperature rising step, the pump 41 is activated and gas is sucked from the kiln body 12 through the exhaust pipe 42 to reduce pressure. The pressure inside the kiln body 12 is controlled to 0.05 MPa or less. The kiln body 12 is rotated around the rotation axis by the driving unit 16 while heated with the heater 14. The lithium sulfate and the activated carbon fed into the kiln body 12 move along the conveying path from the material supply pipe 22 to the material discharge pipe 24 due to the rotation of the kiln body 12. The lithium sulfate and the activated carbon moving along the conveying path are heated to a desired temperature by the heater 14. The lithium sulfate and the activated carbon are not in the fine particle form, and thus scattering in the conveying path is reduced. Thereafter, at the cooling step, the heater 14 is turned off to cool the kiln body 12 and the lithium sulfide. The produced lithium sulfide is then discharged from the material discharge pipe 24 and collected.

[Effect of Embodiment]

According to this embodiment, lithium sulfide can be produced by placing lithium sulfate and the reducing agent in the single furnace and raising the temperature under a reduced pressure atmosphere. According to this embodiment, the by-products can be reduced and the gases generated at the time of reduction can be removed quickly. This embodiment allows lithium sulfide having high purity and no by-products generated to be obtained by performing the reduction at a temperature of 850° C. or more while the pressure is being reduced to 0.05 MPa or less. This embodiment allows lithium sulfide having high purity to be obtained at low costs by performing the reduction under reduced pressure. As described above, this embodiment allows lithium sulfide having high ionic conductivity and no by-products generated to be produced.

In contrast, in order to control an atmosphere under Ar flow, a gas amount of about 10 times or more and about 100 times or less larger than the amount of the generated gas is required, which is not economic.

In this embodiment, the heating is performed in a temperature range of 700° C. or more and 1,000° C. or less and preferably 850° C. or more and 950° C. or less. In this embodiment, setting the temperature range to 700° C. or more and 1,000° C. or less allows the reaction rate to be fast and the productivity to be high. In this embodiment, setting the temperature range to 850° C. or more and 950° C. or less allows lithium sulfate not to melt and thus lithium sulfide retaining the particle shape to be obtained.

In this embodiment, the lithium sulfate used as the raw material is not require to be prepared into fine particles, and thus the increase in the number of processes can be prevented. In the case where the product is produced in the production apparatus 10 having the rotary kiln 11, scattering in the conveying path can be reduced to reduce a decrease in the recovery amount. As described above, this embodiment can provide the method suitable for the producing lithium sulfide using the production apparatus 10 having the rotary kiln 11.

In this embodiment, toxic hydrogen sulfide gas is not used at the production process. According to this embodiment, the production process can be easily controlled and safety can be ensured.

This embodiment uses lithium sulfate and the reducing agent and does not use organic solvents in the production process, resulting in reducing costs.

In this embodiment, the production process is not required to be repeatedly performed, and thus the time required for the production can be shortened and costs can be reduced.

As described above, according to this embodiment, lithium sulfide can be produced more appropriately.

### Example 1

Subsequently, a method of producing lithium sulfide will be described using specific Example 1. At a preparation step, lithium sulfate serving as a raw material and activated carbon serving as a reducing agent were mixed at a predetermined molar ratio in a mortar in a glove box under an inert atmosphere. The predetermined molar ratio was set to 1:2.4. The mixture of lithium sulfate and activated carbon was fed into a crucible formed of aluminum oxide.

After the preparation step, at a temperature rising step, the crucible in which the mixture of lithium sulfate and activated carbon was fed was placed in a small tube furnace and a temperature was raised to 750° C. for 75 minutes. At the time of the temperature rising, a pressure was reduced to a predetermined level by suctioning using the pump 41. A state of 750° C. was maintained over 60 minutes. At the time of the temperature rising step, the kiln body 12 was depressurized to 0.001 MPa or less by the pump 41.

After the completion of the temperature rising step, suction by the pump 41 was stopped. At a cooling step, the inside of the tube furnace was cooled naturally to collect the sample.

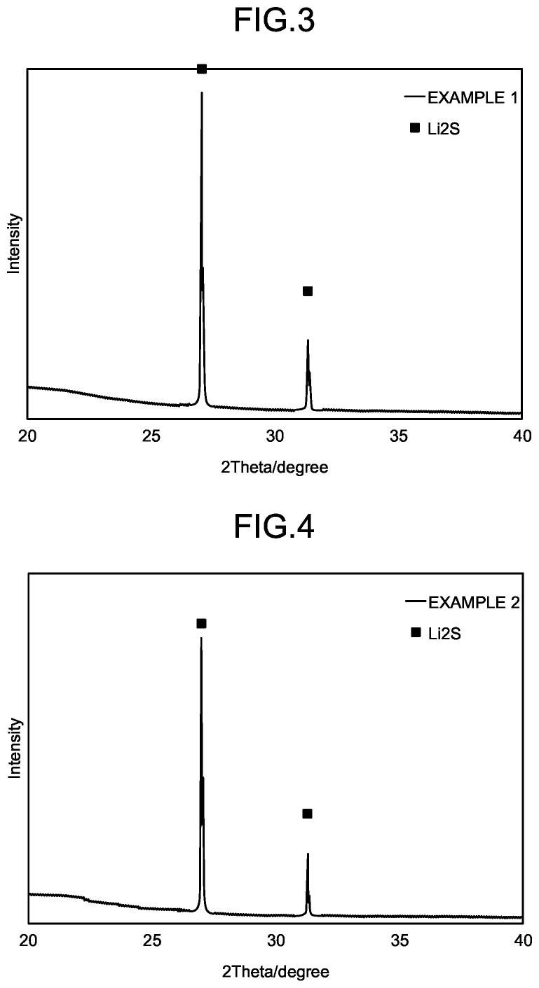

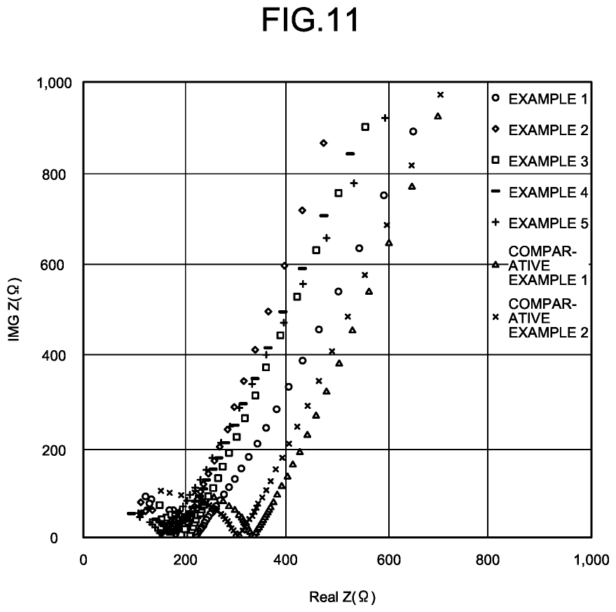

The produced sample was ground in an agate mortar and thereafter powder X-ray diffraction measurement was performed using a D8ADVANCE apparatus manufactured by Bruker Corporation to evaluate an unreacted residue. The ground sample was weighed with phosphorus sulfide at a molar ratio of 3:1 and thereafter processed into an amorphous state with a planetary ball mill using a non-atmospheric exposure vessel. Thereafter, 0.3 g of the processed sample was filled into a conductivity measuring cell made of SUS in the glove box and AC impedance measurement was performed at a room temperature of 25° C. in a measurement range of 1 Hz or more and 7 MHz or less in a state where a pressure of 360 MPa was applied. The measurement result of the powder X-ray diffraction measurement of the produced sample is illustrated in FIG. 3. The measurement result of the AC impedance measurement of the produced sample is illustrated in FIG. 11.

In Example 2 and Example 3, the temperature was varied. In Example 4 and Example 5, the pressure was varied. In Comparative Example 1 and Comparative Example 2, production was performed by varying the flow amounts of Ar flow. In Comparative Example 3, Ar flow was not performed. In Comparative Example 3, the temperature was varied.

### Example 2

In Example 2, the temperature was set to 850° C. and the pressure was set to 0.001 MPa. The measurement result of the powder X-ray diffraction measurement of the sample produced in Example 2 is illustrated in FIG. 4. The measurement result of the AC impedance measurement of the sample produced in Example 2 is illustrated in FIG. 11.

### Example 3

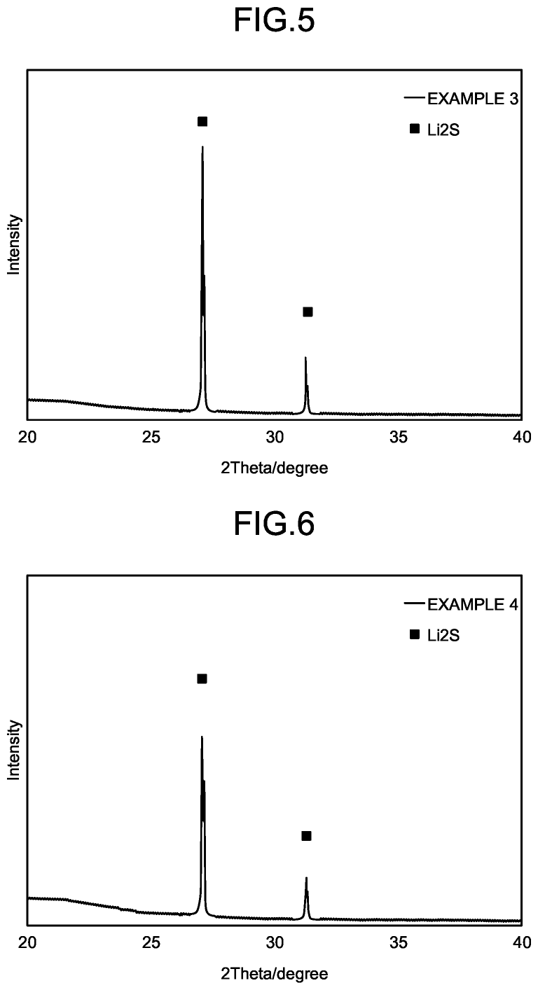

In Example 3, the temperature was set to 1,000° C. and the pressure was set to 0.001 MPa. The measurement result of the powder X-ray diffraction measurement of the sample produced in Example 3 is illustrated in FIG. 5. The measurement result of the AC impedance measurement of the sample produced in Example 3 is illustrated in FIG. 11.

### Example 4

In Example 4, the temperature was set to 850° C. and the pressure was set to 0.05 MPa. The measurement result of the powder X-ray diffraction measurement of the sample produced in Example 4 is illustrated in FIG. 6. The measurement result of the AC impedance measurement of the sample produced in Example 4 is illustrated in FIG. 11.

### Example 5

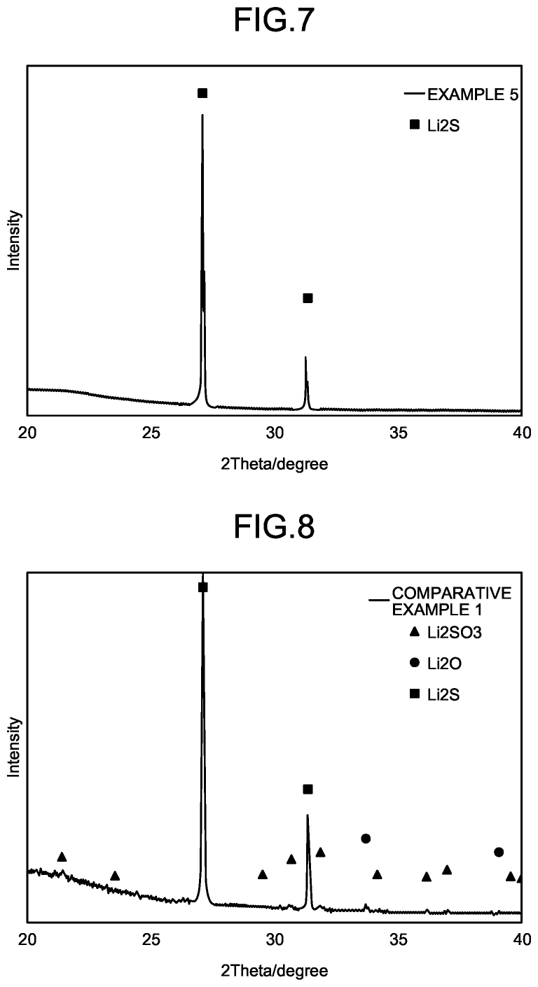

In Example 5, the temperature was set to 850° C. and the pressure was set to 0.0001 MPa. The measurement result of the powder X-ray diffraction measurement of the sample produced in Example 5 is illustrated in FIG. 7. The measurement result of the AC impedance measurement of the sample produced in Example 5 is illustrated in FIG. 11.

### Comparative Example 1

In Comparative Example 1, the temperature was set to 850° C., the Ar flow was set to 1 l/min, and the pressure was set to 0.1 MPa. The measurement result of the powder X-ray diffraction measurement of the sample produced in Comparative Example 1 is illustrated in FIG. 8. The measurement result of the AC impedance measurement of the sample produced in Comparative Example 1 is illustrated in FIG. 11.

### Comparative Example 2

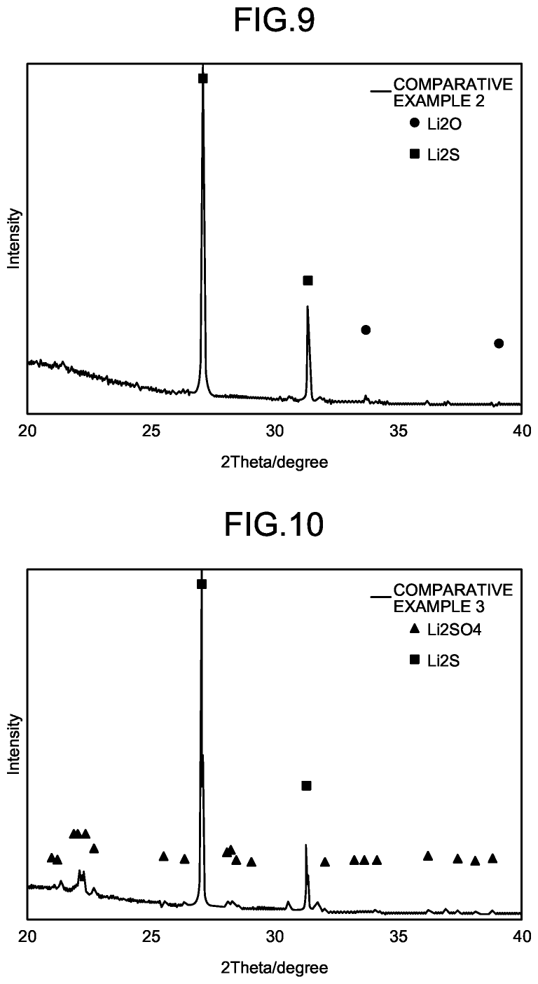

In Comparative Example 2, the temperature was set to 850° C., the Ar flow was set to 2 l/min, and the pressure was set to 0.1 MPa. The measurement result of the powder X-ray diffraction measurement of the sample produced in Comparative Example 2 is illustrated in FIG. 9. The measurement result of the AC impedance measurement of the sample produced in Comparative Example 2 is illustrated in FIG. 11.

### Comparative Example 3

In Comparative Example 3, the temperature was set to 680° C., the Ar flow was not performed, and the pressure was set to 0.001 MPa. The measurement result of the powder X-ray diffraction measurement of the sample produced in Comparative Example 3 is illustrated in FIG. 10. The measurement result of the AC impedance measurement of the sample produced in Comparative Example 3 is not illustrated here because the measurement result was remarkably large as compared to the other Examples and Comparative Examples and did not fit within the same illustration range.

The measurement results of Example 1, Example 2, Example 3, Example 4, Example 5, Comparative Example 1, Comparative Example 2, and Comparative Example 3 are listed in Table 1 below.

TABLE 1

| | | | | XRD | |
|---|---|---|---|---|---|
| | Temperature | Ar | Pressure | Peaks of | |
| | (° C.) | Flow | (MPa) | impurity | Remarks |
| Example 1 | 750 | None | 0.001 | None | |
| Example 2 | 850 | None | 0.001 | None | |
| Example 3 | 1000 | None | 0.001 | None | Powder form |
| | | | | | was not |
| | | | | | obtained due |
| | | | | | to melting |
| Example 4 | 850 | None | 0.05 | None | |
| Example 5 | 850 | None | 0.0001 | None | |
| Comparative | 850 | 1 L/min | 0.1 | Lithium | |
| Example 1 | | | | carbonate | |
| Comparative | 850 | 2 L/min | 0.1 | Lithium | Powder flew |
| Example 2 | | | | oxide | and scattered |
| Comparative | 680 | None | 0.001 | Lithium | Reaction rate |
| Example 3 | | | | sulfate, | was slow |
| | | | | Lithium | |
| | | | | carbonate | |

FIG. 3 to FIG. 7 are graphs that illustrate the test result of each Example (Example 1 to Example 5) and graphs illustrating the measurement results of X-ray diffraction measurement. From Table 1, XRD peaks of impurities are not observed in each Example. The impurities include lithium carbonate and lithium oxide, which are the by-products, and unreduced lithium sulfate. In Example 3, no by-products were observed, but the lithium sulfide melted and was not obtained in a powder form. In Comparison 1, lithium carbonate was observed. In Comparative Example 2, lithium oxide was observed. In Comparative Example 2, the powder flew and scattered. In Comparative Example 3, the unreduced lithium sulfate and the generation of lithium carbonate were observed. In Comparative Example 3, the reaction rate was slow. From the above observations, the unreduced lithium sulfate and the generation of lithium carbonate can be reduced in each Example as compared to each Comparative Example (Comparative Example 1 to Comparative Example 3). From this test, it was confirmed that the unreduced lithium sulfate and the generation of the by-products were reduced by performing the temperature rising step under a reduced pressure atmosphere and thus lithium sulfide was capable of being more appropriately produced.

FIG. 11 is a graph illustrating the test results of each Example and each Comparative Example and is a graph illustrating the AC impedance measurement. As can be seen from FIG. 11 and Table 1, the resistance values in AC impedance become lower in Example 1 to Example 5, in which the by-products are not generated. On the other hand, in Comparative Example 1 and Comparative Example 2, the resistance values are 1.5 times or more larger than the values in each Example. In Comparative Example 3, the value, which was remarkably large, is not illustrated. The ionic conductivity is calculated by dividing the measured area by the resistance value and the thickness of the measured sample. From these results, it has been confirmed that each Example can achieve higher ionic conductivity than that of each Comparative Example. From this test, it has been confirmed that lithium sulfide having high ionic conductivity and no by-products generated can be produced more appropriately in the case where heating is performed to a temperature of more than 700° C. in the atmosphere in a reduced pressure of 0.05 MPa or less at the temperature rising step.

As described above, in the method of producing lithium sulfide, lithium sulfate having high ionic conductivity can be obtained due to a decrease in the unreduced lithium sulfate and the generation of the by-products by performing the temperature rising step under a reduced pressure atmosphere. As described above, it has been found that lithium sulfate having the desired ionic conductivity can be appropriately produced by performing the production under the conditions described above.

### REFERENCE SIGNS LIST

10 Production Apparatus
11 Rotary Kiln
12 Kiln Body (Furnace)
14 Heater
16 Driving Unit
18 Material Feeder
21 Material Reservoir
22 Material Supply Pipe
24 Material Discharge Pipe

1. A method of producing lithium sulfide, the method comprising:
a temperature rising step of reducing lithium sulfate fed into a furnace in a state of heating to a temperature of more than 700° C. under an atmosphere of a reduced pressure of 0.05 MPa or less.

2. The method of producing lithium sulfide according to claim 1, wherein the temperature rising step is performed by heating to 750° C. or more and 1,000° C. or less in a state where lithium sulfate and a reducing agent are mixed.

3. The method of producing lithium sulfide according to claim 2, wherein the temperature rising step is performed by heating to 850° C. or more and 950° C. or less in the state where lithium sulfate and the reducing agent are mixed.

4. The method of producing lithium sulfide according to claim 1, further comprising a preparation step of feeding lithium sulfate and a reducing agent into the furnace.
